(19) United States
(12) Patent Application Publication
(10) Pub. No.: US 2004/0255408 A1
(43) Pub. Date: Dec. 23, 2004

(54) Nonwoven cleaning substrate and method of use

(75) Inventors: John Norton, Indian Trail, NC (US); Rick Augustine, Angier, NC (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/771,865

(22) Filed: Feb. 4, 2004

Related U.S. Application Data
(60) Provisional application No. 60/445,929, filed on Feb. 7, 2003.

(51) Int. Cl. B60S 3/00

(52) U.S. Cl. 15/21.1; 15/50.1; 15/97.1

(57) ABSTRACT

The present invention is directed to a process for cleaning hard surfaces, wherein the process includes the use of a dual sided nonwoven substrate. One side of the dual sided nonwoven substrate acts to loosen particulate and the opposing side is comprised of one or more three-dimensional surface projections that improve the pick up and retainment of the loosened particulates.

### TECHNICAL FIELD

The present invention generally relates to a process for cleaning hard surfaces, more specifically, the process includes the use of a dual sided nonwoven substrate, wherein one side acts to loosen particulates and the opposing side is comprised of one or more three-dimensional surface projections that improves the pick up and retainment of the loosened particulates.

### BACKGROUND OF THE INVENTION

Traditionally, the process of cleaning hard surfaces includes the use of a liquid or powder cleaning agent, in addition to a cloth or sponge. Generally, a cleaning agent is applied to the soiled surface and then a cloth or sponge is used to work the cleaning agent over the soiled surface so as to break up and remove any grime or dirt. For that dirt and grime which is hard to remove, it becomes necessary to repeat the application of the cleaning agent, rinse the cloth or sponge, and attempt to work the cleaning agent over the soiled surface a second time in order to get the surface completely cleaned.

Due to the planarity of the cloth or sponge surface, the loosened particulates aren't easily removed from the newly cleaned surface. Typically, the loosed particulates need to be scooped, or otherwise collected, into a paper towel, napkin, or the user's hand, and discarded. Additionally, cloths or sponges tend to easily yield to stuck-on dirt and grime, wherein the cloth or sponges exhibits structural failure, and thus the user exerts extra energy into cleaning the soiled surface, which otherwise wouldn't be necessary had the cloth or sponge comprised an attribute that assisted with the cleaning process.

Further, cloths and sponges have been found to promote the growth of bacteria. Hard surfaces, such as counters, kitchen and bathroom sinks, toilets, and floors comprise particulates of food, soap scum, dirt, dust, pollen, and hair, all of which may promote propagation of various biota microbial life. Recently, in order to due away with cloths and sponges, disposable nonwoven wipes have been introduced, wherein the wipes are used one or two times and then discarded. Disposable wipes, such as disposable cleaning and dusting products are commercially available impregnated with or soaked in performance enhancing additives such as oils, disinfecting agents, or the like, which results in a product that is compatible with the end-user's preferred choice of cleaning or polishing agent.

Disposable wipes have made cleaning a more sanitary practice, eliminating the need to reuse damp cloths and sponges. Disposable wipes have also made cleaning more convenient, eliminating the need for cleaning products. The cleaning process itself however, continues to remain labor intensive. A need remains for an improved cleaning process that is less labor intensive, less unpleasant, and less time consuming.

### SUMMARY OF THE INVENTION

The present invention is directed to a process for cleaning hard surfaces, wherein the process includes the use of a dual sided nonwoven substrate. One side of the dual sided nonwoven substrate acts to loosen particulate and the opposing side is comprised of one or more three-dimensional surface projections that improve the pick up and retainment of the loosened particulates.

In accordance with the present invention, the cleaning process entails the use of a dual sided nonwoven substrate. The nonwoven substrate may be either disposable after a single use, semi-durable or otherwise utilized more than once before being disposed, or a durable substrate, which has a limited number of uses, but is also washable in either the home laundering process or in the dishwasher. The nonwoven substrate is a handheld wipe and will be referred to herein as a nonwoven wipe. The nonwoven wipe is comprised of a particle loosening side and an opposing particulate capturing side, wherein the particulate capturing side is comprised of three-dimensional surface projections so as to enhance particulate capture, as well as retainment of particulates. The nonwoven wipe may be utilized in a wet state or a dry state.

The cleaning process that utilizes the nonwoven wipe in a dry state, involves positioning the particulate loosening side over the soiled hard surface. Once positioned, the particulate loosening side is actuated over the soiled area, breaking up the contents of the soiled area. Subsequently, the loosened particulates are captured by the textured three-dimensional topography of the particulate capturing surface.

The cleaning process that utilizes the nonwoven wipe in a wet state, involves holding the dual sided wipe under a water faucet, immersing it into a bucket of water or cleaning solution, and/or introducing a commercial cleaning agent to the wipe or hard surface. The particulate loosening side of the wet dual sided wipe is positioned the over the soiled hard surface. Once positioned, the particulate loosening side is actuated over the soiled area, breaking up the contents of the soiled area. Subsequently, the loosened particulates are captured by the textured three-dimensional topography of the particulate capturing surface.

The cleaning process is less labor intensive, wherein due to the particulate loosening side, less energy is exert to loosen the contents of the soiled surface. The cleaning process is also less unpleasant and less time consuming due to the increased surface area that is offered by the enhanced particulate capturing surface. Imparting one or more three-dimensional surface projections into the particulate capturing surface creates a plurality of receptacles within the surface that are capable of capturing, as well as retaining more particulates.

In one embodiment, the three-dimensional surface projections imparted into the particulate capturing surface of the dual sided wipe is comprised of a variable level of leading surface contact regions as measured across the face of the fabric. The leading surface contact regions are present in the form of projections out of the planar background of the fabric, the prevalence of three-dimensional projections being such that the number and/or dimension of such projections increases as one moves away from the leading edges of the cleaning article.

Other features and advantages of the present invention will become readily apparent from the following detailed description, the accompanying drawings, and the appended claims.

### DESCRIPTION OF THE DRAWINGS

FIG. 1 is a diagrammatic view of an apparatus for manufacturing the particulate capturing surface of the nonwoven wipe, embodying the principles of the present invention;

FIG. 2 is a photomicrograph of a three-dimensional topography for the particulate capturing surface of the nonwoven wipe; and

FIG. 3 is a photomicrograph of the particulate capturing receptacles created within the three-dimensional topography of the particulate capturing surface of the nonwoven wipe.

### DETAILED DESCRIPTION

While the present invention is susceptible of embodiment in various forms, hereinafter is described a presently preferred embodiment of the invention, with the understanding that the present disclosure is to be considered as an exemplification of the invention, and is not intended to limit the invention to the specific embodiment illustrated.

In accordance with the present invention, the improved process for cleaning hard surfaces include the use of a dual sided nonwoven wipe, wherein the wipe is comprised of a particulate loosening side and a particulate capturing side. The cleaning process is a less labor intensive process for removing affixed food, soap scum, dirt, dust, pollen, and hair from hard surfaces, such as kitchen and bathroom counters and sinks, toilets, and floors. The process includes a particulate loosening step, wherein the appropriate particulate loosening surface of the wipe is actuated, such as by rubbing, over the soiled surface in either a back and forth motion, side-to-side motion, circular motion, or a combination thereof, so as to release the particulate matter from the hard surface. Subsequent to loosening the particulate matter, the cleaning process includes a particulate capturing step, wherein the appropriate particulate capturing surface of the wipe is passed over the loosened particulate matter in effort to capture and retain the particulates within the surface of the wipe.

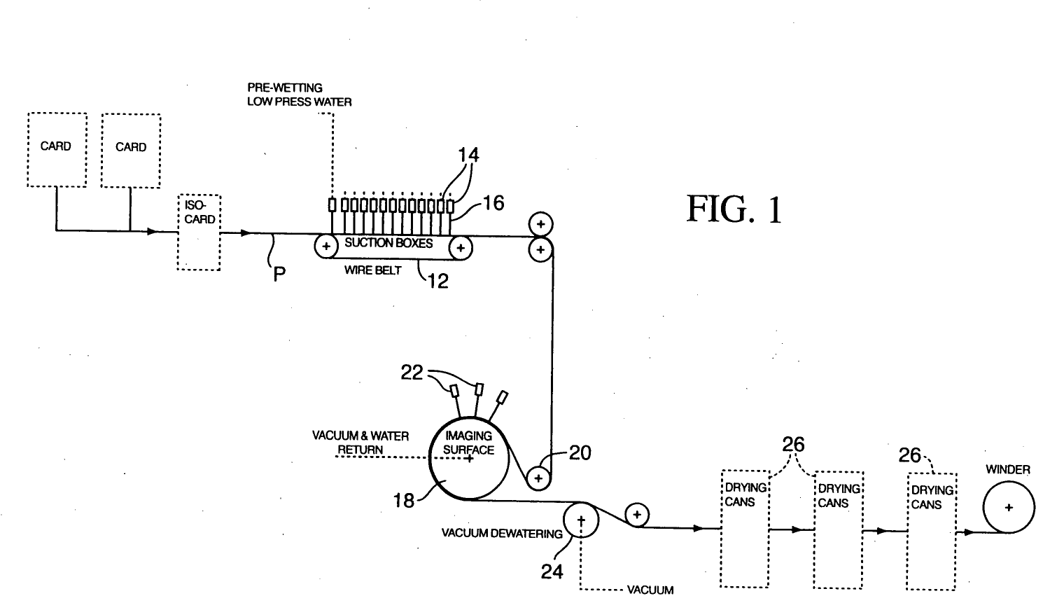

The particulate capturing surface of the nonwoven wipe is comprised of one or more three-dimensional surface projections or apertures. With reference to FIG. 1, therein is illustrated an apparatus for practicing the present method for forming the particulate capturing surface of the nonwoven wipe. The particulate capturing surface may be formed from a fibrous matrix, which typically comprises staple length fibers, but may comprise substantially continuous filaments. The fibrous matrix is preferably carded and cross-lapped to form a fibrous batt, designated F. In a current embodiment, the fibrous batt comprises 100% cross-lap fibers, that is, all of the fibers of the web have been formed by cross-lapping a carded web so that the fibers are oriented at an angle relative to the machine direction of the resultant web. U.S. Pat. No. 5,475,903, hereby incorporated by reference, illustrates a web drafting apparatus.

The apparatus forming the particulate capturing surface includes a foraminous forming surface in the form of a flat bed entangler 12 upon which the precursor web P is positioned for pre-entangling. Precursor web P is then sequentially passed under entangling manifolds 14, whereby the precursor web is subjected to high-pressure water jets 16. This process is well known to those skilled in the art and is generally taught by U.S. Pat. No. 3,485,706, to Evans, hereby incorporated by reference.

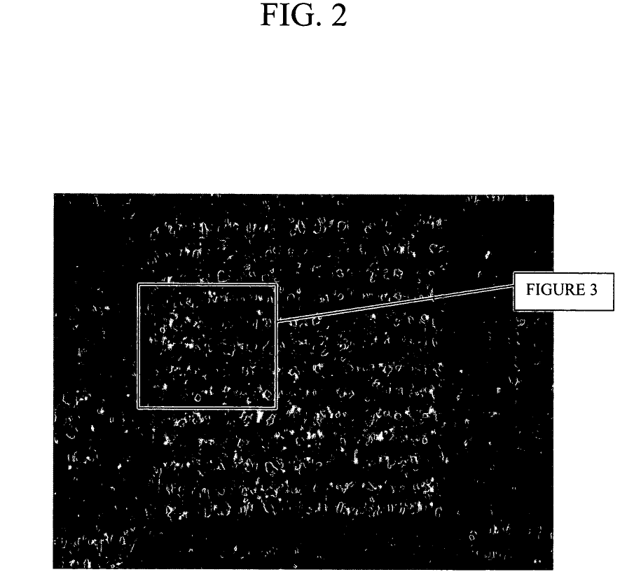

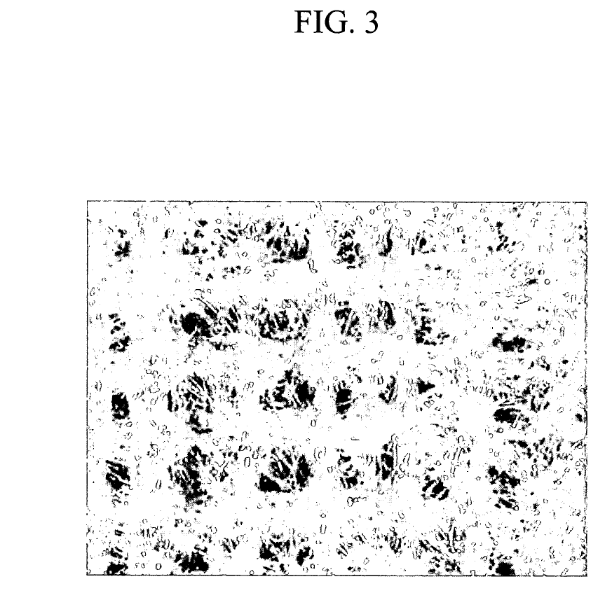

The entangling apparatus of FIG. 1 further includes a drum 18 that imparts three-dimensional surface projections into the now-entangled precursor web. FIGS. 2 and 3 illustrate one possible pattern of surface projections for creating the three-dimensional topography of the particulate capturing surface. FIG. 3 shows the plurality of receptacles that are created within the particulate capturing surface. The receptacles function to improve particulate capture, as well as retaining more particulates.

In a first embodiment, the three-dimensional surface projections imparted into the particulate capturing surface of the dual sided wipe is comprised of a variable level of leading surface contact regions as measured across the face of the fabric. The leading surface contact regions are present in the form of projections out of the planar background of the fabric, the prevalence of three-dimensional projections being such that the number and/or dimension of such projections increases as one moves away from the leading edges of the cleaning article.

In a second embodiment, the particulate capturing surface of the dual sided wipe exhibits a plurality of three-dimensional surface projections whereby the fabric is comprised of at least a first and second three-dimensional surface projection that are dissimilar from one another. The three-dimensional projections may be imparted into the fabric in a co-planar arrangement, multi-planar arrangement, or by utilizing both arrangements within the same fabric.

In a third embodiment, the particulate capturing surface of the dual sided wipe contemplates a fabric comprised of sequential three-dimensional surface projection that are formed from a pre-entangled precursor web entangled on a first three-dimensional transfer device so as to impart a first projection therein, then subjected to hydroentanglement on a second three-dimensional transfer device wherein a second three-dimensional projection is imparted to the web that is different from the first three-dimensional projection, the resulting nonwoven fabric presenting aesthetic and tactile qualities representative of both imparted surface projections.

Optionally, the three-dimensionally topography of the particulate capturing surface may include a support layer or scrim. The support layer material can comprise an array of polymers, such as polyolefins, polyesters, polyurethanes, polyamides, and combinations thereof, and take the form of a film, fibrous sheeting, or grid-like meshes. The support layer is commonly incorporated either by mechanical or chemical means to provide reinforcement to the composite fabric. Reinforcement layers, also referred to as a “scrim” material, are described in detail in U.S. Pat. No. 4,636,419, which is hereby incorporated by reference.

The nonwoven wipe embodying the principles of the present invention can be comprised of fibers or filaments selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending include polyolefins, polyamides and polyesters. The thermoplastic polymers may be further selected from homopolymers; copolymers, conjugates and other derivatives including those thermoplastic polymers having incorporated melt additives or surface-active agents. The profile of the fiber or filament is not a limitation to the applicability of the present invention. Staple lengths are selected in the range of 0.25 inch to 8 inches, the range of 1 to 2 inches being preferred and the fiber denier selected in the range of 1 to 15, the range of 2 to 6 denier being preferred for general applications. The profile of the fiber is not a limitation to the applicability of the present invention.

Thermal stable binders may be incorporated into the nonwoven wipe, wherein either surface, but preferably the particulate loosening surface may be sprayed, immersed, or kiss coated with a binder that is able to withstand a heated washing process. Suitable washing processes include, but are not limited to, the home laundering process or a dishwasher cycle.

The particulate loosening surface of the nonwoven wipe may be comprised of one or more layers of carded fibers or coarse denier meltblown filaments. When staple fibers are utilized to form the particulate loosening surface, the fibers may begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric. The fibrous batt is integrated into a nonwoven fabric by application of suitable bonding means, including, but not limited to, use of thermal stable adhesive binders, thermobonding by calender or through-air oven, and hydroentanglement.

The particulate loosening surface may also comprise coarse denier meltblown filaments, wherein a spunbond resin is utilized with a conventional meltblown process so as to capture thicker filaments. In general, the meltblown process utilizes a molten polymer is extruded under pressure through orifices in a spinneret or die. Traditionally, high velocity air impinges upon and entrains the filaments as they exit the die. Usually the energy of this step is such that the formed filaments are greatly reduced in diameter and are fractured so that microfibers of finite length are produced. Utilizing a spunbond resin with a lower melt flow rate, as well as lowering the air pressure, however, allows the collected filaments to take on a thicker diameter, providing the overall collective web with a desirable coarse texture. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203. The resultant filaments may be of various cross-sectional profiles, which are not considered a limitation to the practice of the present invention.

Optionally, prior to extrusion, the polymeric resin can be compounded with various melt-additives, so as to assist with the processing conditions, enhance the performance of the web, or enhance the appearance of the web, such additives including, but not limited to thermal stabilizers, colorants, aromatics, bacteriacides, bacterastats, triclosan, quatranary amines, and cleaning environment compatible binders.

The particulate loosening and particulate capturing surfaces of the nonwoven wipe may be formed using an in-line process, wherein the particulate loosening surface may be directly formed onto the particulate capturing surface. Also, the particulate loosening and particulate capturing surfaces may be introduced to one another from separate unwind stations, wherein the two surfaces are affixed to one another by suitable bonding means, including, but not limited to, use of adhesive binders, thermobonding by calender or through-air oven, and hydroentanglement.

The nonwoven wipe of the present invention may be either disposable after a single use or semi-durable, utilized more than once before being disposed. Further, the wipe may be comprised of a durable substrate, again limited as to the number of uses, but also washable in one or more home laundering processes or in one or more dishwasher cycles.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. An improved process of cleaning hard surfaces using a nonwoven wipe comprising a surface for loosening affixed particulates, and a surface for improved particulate capture and retainment, wherein said process comprises the steps of:
a. positioning said particulate loosening surface over said affixed particulates;
b. actuating said particulate loosening surface over said affixed particulates; and
c. obtaining said loosened particulates within said three-dimensional topography of said particulate capturing surface.

2. An improved process of cleaning hard surfaces using a nonwoven wipe as in claim 1, wherein said three-dimensional surface projections imparted into the particulate capturing surface comprises a variable level of leading surface contact region as measured across the face of the fabric.

3. An improved process of cleaning hard surfaces using a nonwoven wipe as in claim 1, wherein said particulate capturing surface comprises one or more three-dimensional surface projections.

4. An improved process of cleaning hard surfaces using a nonwoven wipe as in claim 1, wherein said nonwoven wipe may be wet or dry.

5. An improved process of cleaning hard surfaces using a nonwoven wipe as in claim 1, wherein said nonwoven wipe is disposable, semi-durable, or durable.

6. An improved process of cleaning hard surfaces using a durable nonwoven wipe comprising a surface for loosening affixed particulates, and a surface for improved particulate capture and retainment, wherein said process comprises the steps of:
a. positioning said particulate loosening surface over said affixed particulates;
b. actuating said particulate loosening surface over said affixed particulates;
C. obtaining said loosened particulates within said three-dimensional topography of said particulate capturing surface; and
d. washing said nonwoven wipe in a home laundering process or dishwasher cycle.
